(19) United States
(12) Patent Application Publication
(10) Pub. No.: US 2026/0305723 A1
(43) Pub. Date: Oct. 8, 2026

(54) CONTROL METHOD OF AEROSOL GENERATING DEVICE AND AEROSOL GENERATING DEVICE

(71) Applicant: SHENZHEN FIRST UNION TECHNOLOGY CO., LTD., Shenzhen, Guangdong (CN)

(72) Inventors: Chengque YANG, Shenzhen, Guangdong (CN); Jun ZHANG, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/481,730

(22) PCT Filed: Apr. 29, 2024
(86) PCT No.: PCT/CN2024/090655

§ 371 Date: Nov. 5, 2025

(30) Foreign Application Priority Data
May 5, 2023 (CN) 202310499555.4

(51) Int. Cl. A24F 40/57; A24F 40/10; A24F 40/44; A24F 40/46; A24F 40/465; A24F 40/485; H05B 1/02

(52) U.S. Cl. CPC A24F 40/57; A24F 40/10; A24F 40/44; A24F 40/46; A24F 40/465; A24F 40/485; H05B 1/0225

(57) ABSTRACT

A control method of an aerosol generating device and an aerosol generating device. The aerosol generating device includes a heating element. The heating element is configured to heat an aerosol generating product to generate an aerosol. The control method includes turning on the aerosol generating device; determining a turn-off duration of the aerosol generating device, where the turn-off duration is a time interval from a previous turn-off moment to a current turn-on moment of the aerosol generating device; and determining, based on the turn-off duration, a preheating energy of the aerosol generating device, and controlling the heating element to output the preheating energy, to enable the aerosol generating device to reach a predetermined target temperature.

### CROSS-REFERENCE TO RELATED APPLICATIONS

This application claims priority to Chinese Patent Application No. 202310499555.4, filed with the China National Intellectual Property Administration on May 5, 2023 and entitled “CONTROL METHOD OF AEROSOL GENERATING DEVICE AND AEROSOL GENERATING DEVICE”, which is incorporated herein by reference in its entirety.

### TECHNICAL FIELD

This application relates to the field of low-temperature tobacco technologies, and in particular, to a control method of an aerosol generating device and an aerosol generating device.

### BACKGROUND

Traditional tobacco products (such as cigarettes and cigars) burn tobacco during use to produce tobacco smoke. Currently, there are products that release compounds through heat-not-burn to replace these traditional tobacco products. Examples of such products include aerosol generating devices. These devices generally include a heating element. The heating element is configured to heat a cigarette-shaped aerosol generating product inserted into the device, thereby heating and volatilizing some active substances in the aerosol generating product to generate an aerosol.

Existing aerosol generating devices generally use a temperature sensing element to determine whether the device is turned on in a hot state or turned on in a cold state, and then specifically control the heating element to heat the aerosol generating product depending on whether the device is turned on in the hot state or turned on in the cold state, so that an inhalation taste of a user when the device is turned on in the hot state is consistent with an inhalation taste of the user when the device is turned on in the cold state. However, addition of the temperature sensing element correspondingly increases manufacturing costs of the aerosol generating device.

### SUMMARY

Embodiments of this application provide a control method of an aerosol generating device and an aerosol generating device, and provide a manner for recognizing whether the device is turned on in a hot state or in a cold state different from using a temperature sensing element, to resolve a problem that there is a difference between an aerosol taste generated by the aerosol generating device when the device is turned on in the hot state and an aerosol taste generated by the aerosol generating device when the device is turned on in the cold state.

According to an aspect of this application, a control method of an aerosol generating device is provided. The aerosol generating device includes a heating element, the heating element is configured to heat an aerosol generating product to generate an aerosol, and the control method includes: turning on the aerosol generating device; determining a turn-off duration of the aerosol generating device, where the turn-off duration is a time interval from a previous turn-off moment to a current turn-on moment of the aerosol generating device; and determining, based on the turn-off duration, a preheating energy of the aerosol generating device, and controlling the heating element to output the preheating energy, to enable the aerosol generating device to reach a preset target temperature.

In some embodiments, the determining, based on the turn-off duration, a preheating energy of the aerosol generating device, and controlling the heating element to output the preheating energy includes: determining a preheating duration of the aerosol generating device based on the turn-off duration; and controlling, based on the preheating duration, the heating element to output the preheating energy at a predetermined power in the preheating duration, where the preheating duration is a duration required for the heating element to raise a current temperature of the aerosol generating device at the current turn-on moment to the target temperature.

In some embodiments, the controlling, based on the preheating duration, the heating element to output the preheating energy at a predetermined power in the preheating duration includes: determining a difference between a set preheating duration and the preheating duration to obtain a delay duration, where the set preheating duration is a duration for preheating at the predetermined power during heating of the aerosol generating product from an ambient temperature to the target temperature; controlling the heating element to start heating in a case that a power-on time of the aerosol generating device reaches the delay duration; and controlling the heating element to stop heating in a case that a heating duration of the heating element reaches the preheating duration.

In some embodiments, the controlling, based on the preheating duration, the heating element to output the preheating energy at a predetermined power in the preheating duration includes: simultaneously controlling the heating element to start heating at the turn-on moment of the aerosol generating device; and controlling the heating element to stop heating in a case that a heating duration of the heating element reaches the preheating duration, where the preheating duration is less than or equal to a set preheating duration, and the set preheating duration is a duration for preheating at the predetermined power during heating of the aerosol generating product from an ambient temperature to the target temperature.

In some embodiments, the determining a preheating duration of the aerosol generating device based on the turn-off duration includes: determining, based on a preheating duration mapping relationship, a target preheating duration corresponding to the turn-off duration as the preheating duration, where the preheating duration mapping relationship is a mapping relationship between the turn-off duration and the target preheating duration, and the target preheating duration is a duration for preheating at the predetermined power during heating of the aerosol generating product to the target temperature.

In some embodiments, the controlling the heating element to output the preheating energy, to enable the aerosol generating device to reach a preset target temperature includes: determining a supplied energy of the heating element at a current moment; and controlling the heating element to stop heating in a case that the supplied energy reaches the current preheating energy.

In some embodiments, the aerosol generating device includes a controller, and before the turning on the aerosol generating device, the method further includes: in a case that the aerosol generating device is turned off, entering, by the controller, a periodical wakeup mode, storing each wakeup time, and subsequently determining the turn-off duration based on the wakeup time, where the periodical wakeup mode is a mode in which the controller wakes up at regular intervals.

In some embodiments, after the entering, by the controller, a periodical wakeup mode, the method further includes: in a case that a wakeup number of the controller is greater than a predetermined number, exiting, by the controller, the periodical wakeup mode, where the predetermined number is a minimum wakeup number required for the aerosol generating device to cool to an ambient temperature.

In some embodiments, the determining, based on the turn-off duration, a preheating energy of the aerosol generating device includes: obtaining a cooling curve of the aerosol generating device after being turned off, where the cooling curve is a curve of a temperature changing over time after the aerosol generating device is turned off; determining a current temperature of the aerosol generating device at the current turn-on moment based on the turn-off duration and the cooling curve; and determining the preheating energy of the aerosol generating device based on the target temperature and the current temperature.

In some embodiments, after the controlling the heating element to output the preheating energy, to enable the aerosol generating device to reach a preset target temperature, the method further includes: controlling the heating element to start energy supply in a heat preservation stage, where the heat preservation stage includes a plurality of energy output stages.

In some embodiments, the controlling the heating element to start energy supply in a heat preservation stage includes: determining a supplied energy in a current energy output stage; controlling the heating element to stop energy supply in the current energy output stage in a case that the supplied energy reaches an energy corresponding to the current energy output stage; determining a duration for the heating element to stop energy supply in the current energy output stage; and ending the current energy output stage and entering a next energy output stage in a case that the duration reaches a cooling duration of the current energy output stage, where the cooling duration is a duration of a time period for cooling of the energy output stage.

In some embodiments, the controlling the heating element to start energy supply in a heat preservation stage includes: determining a duration for the heating element to stop energy supply in a current energy output stage; controlling the heating element to start heating in a case that the duration reaches a cooling duration of the current energy output stage, where the cooling duration is a duration of a time period for cooling of the energy output stage; determining a supplied energy in the current energy output stage; and in a case that the supplied energy reaches an energy corresponding to the current energy output stage, controlling the heating element to stop energy supply in the current energy output stage, ending the current energy output stage, and entering a next energy output stage.

In some embodiments, the controlling the heating element to start energy supply in a heat preservation stage includes: determining a supplied energy in a current energy output stage; controlling the heating element to stop energy supply in the current energy output stage in a case that the supplied energy reaches an energy corresponding to the current energy output stage; obtaining a real-time temperature of the heating element; and ending the current energy output stage and entering a next energy output stage in a case that the real-time temperature of the heating element drops to a preset low-temperature threshold.

According to another aspect of this application, an aerosol generating device is provided. The aerosol generating device includes a heating element and a controller, the heating element is configured to heat an aerosol generating product to generate an aerosol, and the controller is configured to execute the foregoing control method.

By using the technical solutions of this application, in the control method of an aerosol generating device, first, the aerosol generating device is turned on; then, a turn-off duration of the aerosol generating device is determined, where the turn-off duration is a time interval from a previous turn-off moment to a current turn-on moment of the aerosol generating device; and finally, a preheating energy of the aerosol generating device is determined based on the turn-off duration, and the heating element is controlled to output the preheating energy, to enable the aerosol generating device to reach a predetermined target temperature. According to the method, the corresponding preheating energy is determined based on the turn-off duration of the aerosol generating device, to consider impact of residual heat of the aerosol generating device on preheating, so that when a hot device with the residual heat or a cold device at the room temperature is turned on, an optimum taste temperature of the aerosol of the aerosol generating device can be reached after preheating. In addition, whether the hot device or the cold device is turned on is determined based on the turn-off duration without a need for a temperature sensor, and only the preheating energy is controlled to heat the aerosol to the optimum taste temperature, thereby reducing costs.

### BRIEF DESCRIPTION OF THE DRAWINGS

A part of drawings forming this application illustrated herein are intended to provide further understanding of this application, and schematic embodiments of this application and their descriptions are intended to explain this application and do not constitute undue qualification of this application. In the drawings:

FIG. 1 is a schematic diagram of an aerosol generating device;

FIG. 2 is a schematic diagram of another aerosol generating device;

FIG. 3 is a schematic flowchart of a control method of an aerosol generating device according to an embodiment of this application;

FIG. 4 is a curve of a relationship between a temperature and a time during cooling of an aerosol generating device according to an embodiment of this application;

FIG. 5 is a time sequence diagram of an operating voltage of a heating element of an aerosol generating device according to an embodiment of this application; and

FIG. 6 is a time sequence diagram of an operating voltage of a heating element of an aerosol generating device according to another embodiment of this application.

The foregoing drawings include the following reference numerals:
100: aerosol generating device; 200: aerosol generating product; 10: battery cell; 20: main board; 30: heating element; 40: chamber; and 50: coil.

### DETAILED DESCRIPTION

It should be noted that embodiments in this application and features in the embodiments may be combined with each other in case of no conflicts. This application is described in detail below with reference to the accompanying drawings and in combination with embodiments.

To make a person skilled in the art better understand solutions of this application, technical solutions in the embodiments of this application are clearly and completely described below with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

It should be noted that, in the specification, claims, and accompanying drawings of this application, the terms “first”, “second”, and the like are intended to distinguish between similar objects but do not necessarily indicate a specific order or sequence. The data used in such a way are interchangeable in proper circumstances, so that the embodiments of this application can be described herein. Moreover, the terms “include”, “have”, and any other variants thereof mean are intended to cover the non-exclusive inclusion. For example, a process, method, system, product, or device that includes a list of steps or units is not necessarily limited to those expressly listed steps or units, but may include other steps or units not expressly listed or inherent to such a process, method, product, or device.

The following clearly and completely describes technical solutions in embodiments of this application with reference to the accompanying drawings in the embodiments of this application.

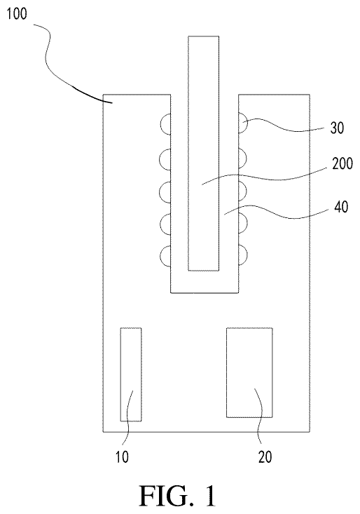

FIG. 1 is a schematic structural diagram of an aerosol generating device 100 according to an embodiment of this application. The aerosol generating device 100 includes a battery cell 10, a main board 20, and a heating element 30. A controller of the aerosol generating device 100 is disposed on the main board 20. The battery cell 10 and the heating element 30 are separately electrically connected to the controller, so that the controller may control the battery cell 10 to provide electric energy to the heating element 30. The aerosol generating device 100 is further provided with a chamber 40 extending in a longitudinal direction. The chamber 40 is configured to accommodate a cigarette-shaped aerosol generating product 200 that is used in combination with the aerosol generating device 100. The heating element 30 is attached to an outer wall of the chamber 40 to heat the aerosol generating product 200 in the chamber 40. Some active substances filled in the aerosol generating product 200 are heated and volatilized to generate an aerosol, and a user can inhale the aerosol by taking a puff on the aerosol generating product 200. In some embodiments, the heating element 30 at least partially extends into the chamber 40, and an end portion of the heating element 30 that extends into the chamber 40 is constructed as a pin shape or a plate shape, so that the heating element 30 is fluently inserted into the aerosol generating product 200 for heating.

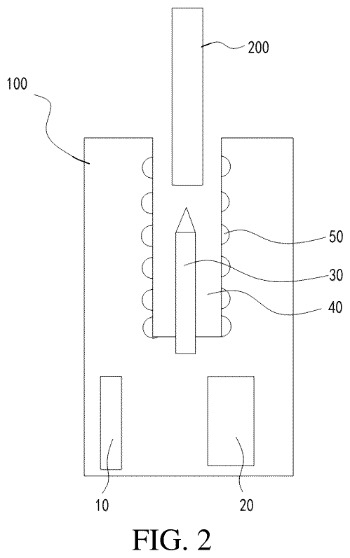

In some embodiments, FIG. 2 is a schematic structural diagram of an aerosol generating device 100 according to another embodiment of this application. The aerosol generating device 100 may alternatively heat the aerosol generating product 200 in an electromagnetic induction heating manner. A coil 50 is wound around the outer wall of the chamber 40, and the battery cell 10 supplies an alternating current to the coil 50. The coil 50 generates a varying magnetic field under an action of the alternating current, and the varying magnetic field penetrates the heating element 30, so that the heating element 30 forms an eddy current through induction. The heating element 30 generates thermal energy under an action of an eddy current effect and a hysteresis effect, thereby heating the aerosol generating product 200. In some embodiments, the heating element includes a resistance material, and the resistance material can generate Joule heat when conducting electricity. In some embodiments, the heating element includes an infrared heating coating. The infrared heating coating generates thermal energy when energized, thereby producing an infrared radiation having a specific wavelength, for example, a 0.75 μm to 1000 μm infrared radiation. In some embodiments, the heating element may be configured to directly heat the aerosol generating product 200, or may be configured to heat air in an airflow channel and heat the air passing through the airflow channel into high-temperature air. The high-temperature air subsequently enters the aerosol generating product 200 to perform heat exchange with the aerosol generating product 200, so that the aerosol generating product 200 is heated and baked.

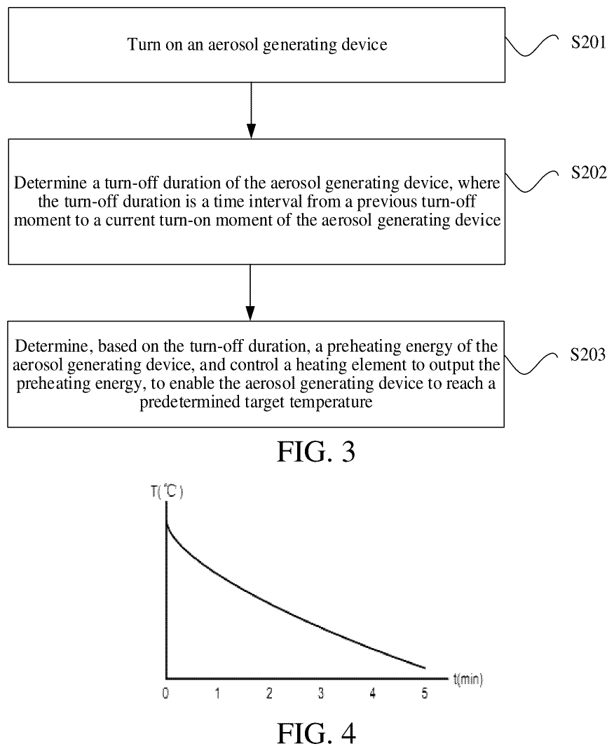

FIG. 3 is a flowchart of a control method of an aerosol generating device according to an embodiment of this application. As shown in FIG. 3, the method includes the following steps:

Step S201: Turn on the aerosol generating device.

Specifically, the aerosol generating device may be a low-temperature smoking device, and the aerosol generating product includes an aerosol-forming substrate including a tobacco material or not including a tobacco material. After the aerosol generating device is turned on, the controller and other components are awakened.

Step S202: Determine a turn-off duration of the aerosol generating device.

The turn-off duration is a time interval from a previous turn-off moment to a current turn-on moment of the aerosol generating device. Specifically, because in a case that the aerosol generating device is turned on again after being turned off for a short time, the aerosol generating device is not cooled to the room temperature, there is residual heat. As shown in FIG. 4, a temperature at which the aerosol generating device is turned on is related to the current turn-off duration when the aerosol generating device is turned on. The turn-off duration when the aerosol generating device is turned on is a duration from the previous turn-off moment to the current turn-on moment of the aerosol generating device, that is, the current turn-off duration. A shorter current turn-off duration indicates a higher residual temperature of the heating element when the aerosol generating device is turned on.

In some embodiments, the controller may collect all turn-off durations to determine the time interval between the current turn-on moment and the previous turn-off moment. In other embodiments, the controller may alternatively collect only some turn-off durations, and when the collected turn-off durations exceed a preset time threshold, a next turn-on can be determined as a turn-on in a cold state, and subsequent turn-off durations no longer need to be collected.

Step S203: Determine, based on the turn-off duration, a preheating energy of the aerosol generating device, and control the heating element to output the preheating energy, to enable the aerosol generating device to reach a predetermined target temperature.

Generally, when the aerosol generating device is turned on, power is immediately outputted to the heating element, to start a preheating stage, so that the aerosol generating product is preheated and a temperature of the aerosol-forming substrate is increased to reach a temperature at which a satisfactory amount of the aerosol is generated. The aerosol may be generated in the preheating stage, but is generally not inhaled out of the device by the user.

Specifically, for different turn-off durations from the turn-on moment to the previous turn-off moment of the aerosol generating device, the temperature of the heating element of the aerosol generating device at the turn-on moment is also different, and the preheating energy required for the aerosol generating device to preheat from the temperature at the turn-on moment to the target temperature is also different. Different preset preheating energies are given to the heating element based on turn-on of a cold device or a hot device, to heat the aerosol generating product to complete preheating, thereby ensuring that after preheating, the aerosol generating device reaches an optimum taste temperature of the aerosol, thereby eliminating differences in the taste caused by different residual heat.

First, the aerosol generating device is turned on; then, the turn-off duration of the aerosol generating device is determined, where the turn-off duration is the time interval from the previous turn-off moment to the current turn-on moment of the aerosol generating device; and finally, the preheating energy of the aerosol generating device is determined based on the turn-off duration, and the heating element is controlled to output the preheating energy, to enable the aerosol generating device to reach the predetermined target temperature. According to the method, the corresponding preheating energy is determined based on the turn-off duration of the aerosol generating device. Based on the different turn-off durations, impact of residual heat of the aerosol generating device on preheating is specifically considered, so that when a hot device with the residual heat or a cold device at the room temperature is turned on, an optimum taste temperature of the aerosol of the aerosol generating device can be reached after preheating. In this way, an aerosol taste of the aerosol generating device when the device is turned on in the hot state is consistent with an aerosol taste of the aerosol generating device when the device is turned on in the cold state, and whether the hot device or the cold device is turned on is determined based on the turn-off duration without a need for a temperature sensor. Therefore, only the preheating energy is controlled to heat the aerosol to the optimum taste temperature, thereby reducing costs.

To facilitate control of the preheating energy outputted to the heating element, in an optional implementation, step S203 includes:

Step S2031: Determine a preheating duration of the aerosol generating device based on the turn-off duration.

A memory in the aerosol generating device may preset a correspondence between the turn-off duration and the preheating duration. The preheating duration is a duration required for the heating element to raise a current temperature of the aerosol generating device at the current turn-on moment to the target temperature (which may be alternatively understood as a highest temperature in the preheating duration) through heating.

Step S2032: Control, based on the preheating duration, to output the preheating energy to the heating element at a predetermined power in the preheating duration.

Specifically, because energy is an integral of power over time, if the heating power is not fixed, it is difficult to control the heating energy only by controlling a heating time. Therefore, the preheating energy outputted by the heating element may be accurately controlled by controlling the preheating duration by setting a fixed heating power by using the heating element, which is simple and convenient.

For ease of application, in an optional implementation, step S2032 includes:

Step S20321: Determine a difference between a set preheating time and the preheating duration to obtain a delay duration. The set preheating time is a duration required for preheating at the predetermined power during heating of the aerosol generating product from an ambient temperature to the target temperature.

Step S20322: Control the heating element to start heating in a case that a power-on time of the aerosol generating device reaches the delay duration.

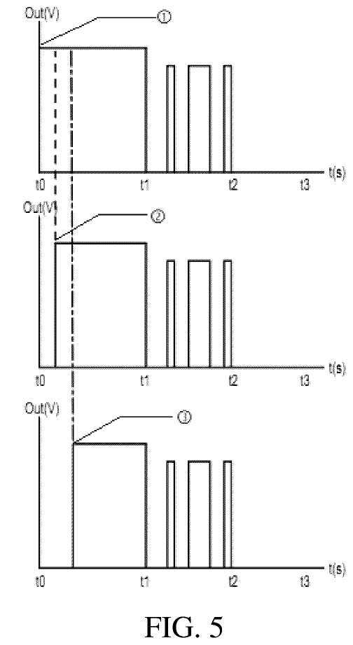

As shown in FIGS. 5, \textcircled{1} represents energy output when the aerosol generating device is turned on in the cold state, and \textcircled{2} and \textcircled{2} represent that energy output is started when the aerosol generating device is turned on in the hot state and in a case that the power-on time of the aerosol generating device reaches the delay duration. \textcircled{2} and \textcircled{3} respectively represent cases that the turn-off duration is different, and the output energy or the delay duration is different correspondingly. \textcircled{2} represents a case that the device is turned on in the hot state and the turn-off duration is long, and \textcircled{3} represents a case that the device is turned on in the hot state and the turn-off duration is short, where the delay duration of \textcircled{2} is less than the delay duration of \textcircled{3}.

Step S20323: In a case that a heating duration of the heating element reaches the preheating duration, control the heating element to stop heating or enter a next stage, to meet requirements of the next stage (a heat preservation stage) to control the output energy/power to the heating element.

Specifically, the aerosol generating device generally sets a fixed preheating time to facilitate control of a time point for ending preheating and entering the heat preservation stage, and the fixed preheating time is greater than or equal to the preheating duration for turning on the device in the cold state, to ensure that the aerosol generating product can be preheated to the target temperature regardless of turning on the device in the cold state or turning on the device in the hot state. As shown in FIG. 5, after the aerosol generating device is turned on, preheating is delayed for a period of time, so that the heat preservation stage is entered when preheating ends.

For ease of application, in an optional implementation, step S2032 includes:

Step S20324: Simultaneously control the heating element to start heating at the turn-on moment of the aerosol generating device.

Step S20325: Control the heating element to stop heating in a case that the heating duration of the heating element reaches the preheating duration.

The preheating duration is less than or equal to a set preheating duration, and the set preheating duration is a duration for preheating at the predetermined power during heating of the aerosol generating product from the ambient temperature to the target temperature.

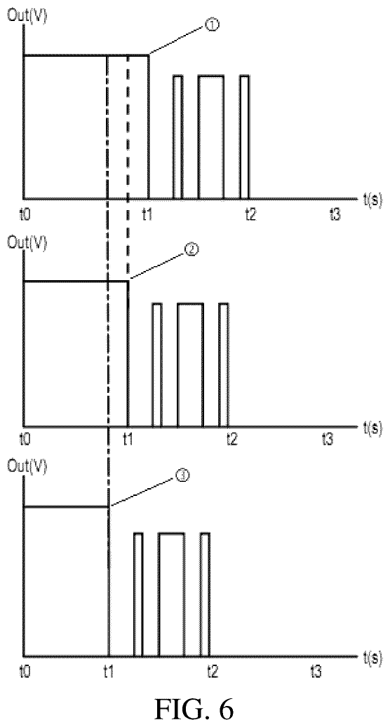

As shown in FIGS. 6, \textcircled{1} shows energy output when the device is turned on in the cold state, and t0 to t1 may be understood as the set preheating time; and \textcircled{2} and \textcircled{3} represent that when the aerosol generating device is turned on in the hot state, the aerosol generating device ends the power/energy supply to the heating element in advance. \textcircled{2} and \textcircled{3} respectively represent cases that the turn-off duration is different, and the output energy is different correspondingly. \textcircled{2} represents a case that the device is turned on in the hot state and the turn-off duration is long, and \textcircled{3} represents a case that the device is turned on in the hot state and the turn-off duration is short, where the heating duration of \textcircled{2} is greater than the heating duration of \textcircled{1}.

Specifically, the aerosol generating device generally sets a fixed preheating time to facilitate control of a time point for ending preheating and entering the heat preservation stage, and the fixed preheating time is greater than or equal to the preheating duration for turning on the device in the cold state, to ensure that the aerosol generating product can be preheated to the target temperature regardless of turning on the device in the cold state or turning on the device in the hot state. As shown in FIG. 6, first, after the device is turned on, preheating is directly performed to reach the preheating duration. Heating may be stopped for a period of time, and then the heat preservation stage is entered. The heating element first reaches the target temperature. Consequently, the temperature of the heating element may drop below the target temperature, or may be maintained at the target temperature, to avoid overshoot of a heating temperature of the aerosol generating product and affect a taste.

Specifically, at the turn-on moment of the aerosol generating device, the heating element is simultaneously controlled to start heating. When the heating duration reaches the preheating duration, heating is ended in advance, which is equivalent to ending the preheating stage in advance, and the heat preservation stage can be entered as soon as preheating ends. To improve heating efficiency, even if the device is turned on in the hot state, it is unnecessary to wait for a period of time until the fixed preheating time is satisfied, to avoid that an unexpected drop of the temperature of the aerosol generating product affects the taste. In some embodiments, as shown in FIG. 6, the heating element is controlled to end heating in advance. The heating element ends heating until the fixed preheating time is satisfied and then the heat preservation stage is entered. However, the temperature of the aerosol generating product that has reached the maximum temperature may be caused to fall back. The two manners are suitable for different heating requirements of the aerosol generating product.

Specifically, a target preheating duration corresponding to the turn-off duration is determined as the preheating duration; and a mapping relationship of the preheating duration may be understood as a mapping relationship between the turn-off duration and the target preheating duration, and the target preheating duration is a duration for preheating at the predetermined power during heating of the aerosol generating product to the target temperature.

Specifically, because the turn-off duration when the aerosol generating device is turned on is different, the temperature at which the heating element is turned on is different, and the preheating duration required for the aerosol generating device to preheat from the temperature at the turn-on moment to the target temperature is also different. The mapping relationship between the current turn-off duration and the target preheating duration is established by using a calibration experiment, so that the target preheating duration corresponding to the current turn-off duration may be determined as the preheating duration based on the mapping relationship of the preheating duration.

To apply to more application scenarios, in an optional implementation, step S203 includes:

Step S2033: Determine a supplied energy of the heating element at a current moment.

Step S2034: Control the heating element to stop heating in a case that the supplied energy reaches the current preheating energy.

Specifically, in an actual application process, the heating power of the heating element may not be kept constant, and whether to end preheating may not be determined based on the duration, but is directly determined depending on whether the energy reaches a preset energy, so that the control method is applicable to more application scenarios.

To reduce power consumption, in an optional implementation, the aerosol generating device includes a controller. Before step S201, the method further includes:

Step S301: In a case that the aerosol generating device is turned off, the controller enters a periodical wakeup mode, stores each wakeup time, and subsequently determines the turn-off duration based on the wakeup time, where the periodical wakeup mode is a mode in which the controller wakes up at regular intervals.

Specifically, when the aerosol generating device is turned off, the controller enters the periodical wakeup mode, that is, enters a sleep state and wakes up at an interval of a predetermined time. Timing can be implemented based on the wakeup time to determine the turn-off time, without a need to keep the controller in a working state, greatly reducing power consumption.

To further reduce power consumption, in an optional implementation, after step S301, the method further includes:

Step S302: In a case that a wakeup number of the controller is greater than a predetermined number, the controller exists the periodical wakeup mode, where the predetermined number is a minimum wakeup number required for the aerosol generating device to cool to an ambient temperature.

Specifically, when the turn-off duration of the aerosol generating device exceeds a minimum duration for turning on the cold device, timing is no longer necessary. The minimum duration for turning on the cold device refers to a minimum time required to cool to the ambient temperature. A predetermined number is determined based on the duration and the wakeup interval. That is, once the wakeup number exceeds the predetermined number, timing is ended, and that the cold device is turned on is directly determined. The controller then exits the periodical wakeup mode and remains dormant, further reducing power consumption.

To further simplify the preheating method, in an optional implementation, step S203 includes:

Step S2035: Obtain a cooling curve of the aerosol generating device after being turned off, where the cooling curve is a curve of a temperature changing over time after the aerosol generating device is turned off.

Step S2036: Determine a current temperature of the aerosol generating device at the current turn-on moment based on the turn-off duration and the cooling curve.

Step S2037: Determine the preheating energy of the aerosol generating device based on the target temperature and the current temperature.

Specifically, as shown in FIG. 4, FIG. 4 is a curve of a temperature changing over time after an aerosol generating device is turned off. A temperature corresponding to the cooling curve may be found based on the turn-off duration, and the current temperature of the aerosol generating device at the current turn-on moment is determined, thereby determining, based on a temperature difference between the target temperature and the current temperature, the preheating energy required for preheating to the target temperature. The mapping relationship between the current turn-off duration and the target preheating duration does not need to be established through a calibration experiment to control the preheating duration to implement preheating, thereby simplifying a preheating method.

To ensure the taste of the aerosol, in an optional implementation, after step S203, the method further includes:

Step S401: Control the heating element to start energy supply in a heat preservation stage, where the heat preservation stage includes a plurality of energy output stages.

Specifically, as shown in FIG. 5 and FIG. 6, after preheating is completed, the heat preservation stage (t₁ to t₂ stage) is entered, and the heat preservation stage includes a plurality of energy output stages.

In some embodiments, by determining the supplied energy in the current energy output stage, in a case that the supplied energy reaches an energy corresponding to the current energy output stage, the heating element is controlled to stop energy supply in the current energy output stage. Subsequently, a duration for the heating element to stop energy supply in the current energy output stage is determined. In a case that the duration reaches a cooling time set for the current energy output stage, the current energy output stage is ended and a next energy output stage is entered. This may be understood as a heat preservation stage. The heat preservation stage includes a plurality of energy output stages. Each energy output stage includes a period of time for heating and a period of time for cooling, and then a next energy output stage is entered. Each energy output stage has corresponding energy supply. Heating is stopped and cooling is performed when a duration corresponding to energy supply is reached. Heating is stopped without detecting, by using the temperature sensor, that the temperature reaches the target temperature. The next energy output stage may be entered when a cooling duration reaches a cooling duration corresponding to the energy output stage, and the next energy output stage may be also entered without detecting that the temperature is reduced to the temperature threshold by using the temperature sensor, to avoid a problem that inaccurate temperature detection causes impact on the taste. Certainly, the energy output stages are not limited to performing heating first and then cooling, or may perform cooling first and then heating.

In some embodiments, the supplied energy of the current energy output stage is determined, and the heating element is controlled to stop energy supply in the current energy output stage in a case that the supplied energy reaches the energy corresponding to the current energy output stage; and a real-time temperature of the heating element is obtained in a process of stopping outputting energy supply, and the current energy output stage is ended and the next energy output stage is entered in a case that the real-time temperature of the heating element drops to a preset low-temperature threshold. This manner requires coordinated use of the temperature sensing element.

In some embodiments, in a process of supplying energy to the heating element, the real-time temperature of the heating element is obtained. In a case that the real-time temperature of the heating element rises to a preset high-temperature threshold, the heating element is controlled to stop energy supply in the current energy output stage. In a process of stopping outputting energy supply, the real-time temperature of the heating element is obtained. In a case that the real-time temperature of the heating element drops to a preset low-temperature threshold, the current energy output stage is ended, and the next energy output stage is entered. This manner also requires coordinated use of the temperature sensing element.

It should be noted that although a logic sequence is shown in the flowchart, in some cases, the shown or described steps may be performed in a sequence different from the sequence herein.

An embodiment of this application further provides an aerosol generating device. The aerosol generating device includes a heating element and a controller, the heating element is configured to heat an aerosol generating product to generate an aerosol, and the controller is configured to: turn on the aerosol generating device, determine a turn-off duration of the aerosol generating device, where the turn-off duration is a time interval from a previous turn-off moment to a current turn-on moment of the aerosol generating device, and determine, based on the turn-off duration, a preheating energy of the aerosol generating device, and control the heating element to output the preheating energy, to enable the aerosol generating product to reach a predetermined target temperature.

In the foregoing aerosol generating device, the controller is configured to: turn on the aerosol generating device, determine the turn-off duration of the aerosol generating device, where the turn-off duration is the time interval from the previous turn-off moment to the current turn-on moment of the aerosol generating device, and determine, based on the turn-off duration, the preheating energy of the aerosol generating device, and control the heating element to output the preheating energy, to enable the aerosol generating product to reach the predetermined target temperature. That is, the corresponding preheating energy is determined based on the turn-off duration of the aerosol generating device, to consider impact of residual heat of the aerosol generating device on preheating caused by the turn-off duration, so that when a hot device with the residual heat or a cold device at the room temperature is turned on, an optimum taste temperature of the aerosol of the aerosol generating device can be reached after preheating. In this way, a problem that there is a difference between an aerosol taste of the aerosol generating device when the device is turned on in the hot state and an aerosol taste of the aerosol generating device when the device is turned on in the cold state is solved, and whether the hot device or the cold device is turned on is determined based on the turn-off duration without a need for a temperature sensor. Therefore, only the preheating energy is controlled to heat the aerosol to the optimum taste temperature, thereby reducing costs.

It should also be noted that the terms “include”, “comprise”, and any other variants mean to cover the non-exclusive inclusion. Thereby, the process, method, article, or device that includes a series of elements not only include those elements, but also include other elements not clearly listed, or include the inherent elements of the process, method, article and device. Without further limitation, the element defined by a phrase “include one . . . ” does not exclude other same elements in the process, method, article, or device that includes the element.

From the foregoing descriptions, it can be seen that the embodiments of this application may achieve the following technical effects. In the aerosol generating device and the control method thereof in this application, first, the aerosol generating device is turned on; then, a turn-off duration of the aerosol generating device is determined, where the turn-off duration is a time interval from a previous turn-off moment to a current turn-on moment of the aerosol generating device; and finally, a preheating energy of the aerosol generating device is determined based on the turn-off duration, and the heating element is controlled to output the preheating energy, to enable the aerosol generating device to reach a predetermined target temperature. In this method, the corresponding preheating energy is determined based on the turn-off duration of the aerosol generating device, to consider impact of residual heat of the aerosol generating device on preheating caused by the turn-off duration, so that when a hot device with the residual heat or a cold device at the room temperature is turned on, an optimum taste temperature of the aerosol of the aerosol generating device can be reached after preheating. In this way, a problem that there is a difference between an aerosol taste of the aerosol generating device when the device is turned on in the hot state and an aerosol taste of the aerosol generating device when the device is turned on in the cold state is solved, and whether the hot device or the cold device is turned on is determined based on the turn-off duration without a need for a temperature sensor. Therefore, only the preheating energy is controlled to heat the aerosol to the optimum taste temperature, thereby reducing costs.

The foregoing descriptions are merely preferred embodiments of this application, but are not intended to limit this application. A person skilled in the art may make various modifications and variations to this application. Any modification, equivalent replacement, or improvement made without departing from the spirit and the principle of this application shall fall within the protection scope of this application.

1. An atomizer, comprising:
a housing, wherein a liquid storage cavity for storing a liquid substrate is formed inside the housing; and one end of the housing is provided with a suction nozzle having a suction nozzle opening for aerosol output;
an atomizing assembly, configured to atomize the liquid substrate to generate an aerosol;
an atomizing tube, formed by stretching a metal substrate, wherein the atomizing tube defines at least a part of an air outlet channel, and the air outlet channel is used for guiding the aerosol to the suction nozzle opening; and
a closed-ring snap-fit member, wherein the snap-fit member surrounds the atomizing tube and is fixed on an outer surface of the atomizing tube adjacent to the suction nozzle, the snap-fit member comprises a clamping end extending in a radial direction of the atomizing tube, the suction nozzle is provided with a fitting member, and at least a part of the fitting member is configured to pass over the snap-fit member in an axial direction to form snap-fit connection with the clamping end.

2. The atomizer according to claim 1, wherein a protrusion size of the clamping end in the radial direction of the atomizing tube is greater than 0.3 mm.

3. The atomizer according to claim 1, wherein the fitting member has an undercut structure, and the undercut structure abuts against the clamping end of the snap-fit member.

4. The atomizer according to claim 1, wherein the fitting member is provided with a notch.

5. The atomizer according to claim 1, wherein a connecting sleeve is further provided between the suction nozzle and the housing; and the fitting member is arranged in the connecting sleeve.

6. The atomizer according to claim 5, wherein a part of an inner wall of the connecting sleeve abuts on the fitting member; and another part of the inner wall of the connecting sleeve abuts on the atomizing tube.

7. The atomizer according to claim 6, wherein a sealing element is arranged between the connecting sleeve and the atomizing tube, and the sealing element is arranged at one end of the connecting sleeve away from the suction nozzle.

8. The atomizer according to claim 1, wherein the atomizing assembly comprises a liquid guide assembly and a heating element, the liquid guide assembly comprises a first liquid guide element and a second liquid guide element, the second liquid guide element is arranged around at least a part of the first liquid guide element, and the heating element is fixed on the first liquid guide element.

9. The atomizer according to claim 8, wherein the hardness of the first liquid guide element is greater than the hardness of the second liquid guide element.

10. The atomizer according to claim 8, wherein a liquid guide capability of the second liquid guide element is greater than a liquid guide capability of the first liquid guide element.

11. The atomizer according to claim 1, wherein the snap-fit member is riveted on an outer surface of the atomizing tube.

12. The atomizer according to claim 1, wherein the atomizing tube comprises a first section and a second section connected in sequence, an outer diameter of the second section is greater than an outer diameter of the first section, and the snap-fit member is fixed on an outer surface of the first section.

13. The atomizer according to claim 12, wherein the first section has a uniform outer diameter in an axial extension direction.

14. The atomizer according to claim 12, wherein the atomizing tube further comprises a third section that is away from the first section and connected to the second section, an outer diameter of the third section is greater than the outer diameter of the second section, and the atomizing assembly is accommodated in the third section.

15. An aerosol generating device, comprising:
the atomizer according to claim 1; and
a power supply assembly that provides electric drive for the atomizer.

16. An atomizing tube assembly for an atomizer, comprising:
an atomizing tube, formed by stretching a metal substrate, wherein the atomizing tube defines at least a part of an air outlet channel, the atomizing tube comprises a first section, a second section, and a third section connected in sequence, and outer diameters of the first section, the second section, and the third section increase in sequence; and
a closed-ring snap-fit member, wherein the snap-fit member surrounds the first section of the atomizing tube and is fixed on an outer surface of the first section, the snap-fit member comprises a clamping end extending in a radial direction of the atomizing tube, and the clamping end is used for forming snap-fit connection with a suction nozzle in the atomizer.
